(19) United States
(12) Patent Application Publication
(10) Pub. No.: US 2014/0293263 A1
(43) Pub. Date: Oct. 2, 2014

(54) LIDAR Comprising Polyhedron Transmission and Receiving Scanning Element

(71) Applicants: James Justice, Newport Beach, CA (US); Medhat Azzazy, Laguna Niguel, CA (US); David Ludwig, Irvine, CA (US)

(72) Inventors: James Justice, Newport Beach, CA (US); Medhat Azzazy, Laguna Niguel, CA (US); David Ludwig, Irvine, CA (US)

(21) Appl. No.: 13/852,457

(22) Filed: Mar. 28, 2013

(51) Int. Cl. G01S 17/93; G05D 1/02

(52) U.S. Cl. CPC G01S 17/936; G05D 1/0231
USPC 356/4.01

(57) ABSTRACT

A LIDAR system having a rotating geometric solid polyhedron reflective scanning and receiving element disposed on a rotation table element. The system is configured for scanning a transmitted electromagnetic beam such as a laser beam over a scene of interest in both elevation and azimuth and for receiving a reflected portion of the transmitted beam onto the focal plane detector array of the invention and to output an (x, y, range) set of point cloud coordinate image data.

### CROSS-REFERENCE TO RELATED APPLICATIONS

This application claims the benefit of U.S. Provisional Patent Application No. 61/617,160, filed on Mar. 29, 2012, entitled “LIDAR for Autonomous Land Vehicle Navigation Support” pursuant to 35 USC 119, which application is incorporated fully herein by reference.

### STATEMENT REGARDING FEDERALLY SPONSORED RESEARCH AND DEVELOPMENT

N/A

### BACKGROUND OF THE INVENTION

1. Field of the Invention

The invention relates generally to the field of LIght Detection And Ranging systems or “LIDAR” systems. More specifically, the invention relates to a LIDAR system that uses a rotating geometric solid polyhedron reflective scanning and receiving element disposed on a rotating base element configured for scanning a transmitted electromagnetic beam over a scene of interest in both elevation and azimuth and for receiving a reflected portion of the transmitted beam onto the focal plane detector array of the invention.

2. Description of the Related Art

Autonomous land vehicles are a key element of future combat operations when operating in support of troop movements. When operated as materiel carriers, autonomous land vehicles can significantly off-load individual troop-carried materiel and relieve the increasing burden of weight borne by the individual soldier.

Cost-effectiveness of such capabilities is increasingly important in an environment of limited budgets. The cost of autonomous land vehicle operations in this class is largely determined by the active sensor systems required to provide timely and accurate three-dimensional (“3-D”) imagery of the approaching terrain and of activities surrounding the autonomous vehicle using LIght Detection And Ranging or “LIDAR” imaging.

Applicant has examined the currently available LIDAR component technologies and discloses herein an invention that is a low-cost, yet high-performance, 3-D LIDAR system operating in the eye-safe SWIR spectral region that addresses the needs of the above and other LIDAR applications.

### BRIEF SUMMARY OF THE INVENTION

In a first aspect of the invention, an electronic imaging device is disclosed comprising an electromagnetic radiation source such as a laser source for transmitting an electromagnetic beam in a predetermined range of the electromagnetic spectrum.

An elevation scanning element may be provided defining a geometric polyhedron solid comprising at least one substantially flat and electromagnetically reflective facet disposed about the perimeter of the scanning element. The scanning element is configured to rotate about a first axis by a drive motor in a first direction whereby the transmitted laser beam is scanned in elevation in the first direction over a scene of interest by the plurality of facets. The invention may further comprise a rotation table configured to rotate and scan the transmitted laser beam over the scene of interest in a direction substantially orthogonal to the first direction such as in azimuth, and a focal plane detector array for converting a reflected portion of the beam received from the scene of interest from the facet into a detector output signal. The transmitted laser is scanned, and the reflected laser energy from the scene is received by the same facet at the same time.

This and various additional aspects, embodiments and advantages of the present invention will become immediately apparent to those of ordinary skill in the art upon review of the Detailed Description and any claims to follow.

While the claimed apparatus and method herein has or will be described for the sake of grammatical fluidity with functional explanations, it is to be understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112, are to be accorded full statutory equivalents under 35 USC 112.

### BRIEF DESCRIPTION OF THE SEVERAL VIEWS OF THE DRAWINGS

FIG. 1 depicts a preferred embodiment of the system of the invention illustrating certain of its major elements.

FIG. 2 depicts exemplar measurements of a laser return of the system from multiple range bins for a near surface, a more distant surface and a near and more distant surface respectively.

FIG. 3 is a block diagram of a preferred embodiment of the system of the invention illustrating certain of its major elements.

FIGS. 4A and 4B are an exemplar layout of a set of printed circuit boards for use in a preferred embodiment of the invention.

FIG. 5 is an FPA circuit electronics block diagram and related waveforms.

FIG. 6 is an illustration of a sampling for a 7.5 cm scene resolution.

FIG. 7 is an exemplar scan pattern for a system of the invention.

FIG. 8 is a signal-to-noise estimation methodology.

FIG. 9 depicts laser temporal pulse energy in a single clock bin.

The invention and its various embodiments can now be better understood by turning to the following detailed description of the preferred embodiments which are presented as illustrated examples of the invention defined in the claims.

It is expressly understood that the invention as defined by the claims may be broader than the illustrated embodiments described below.

### DETAILED DESCRIPTION OF THE INVENTION

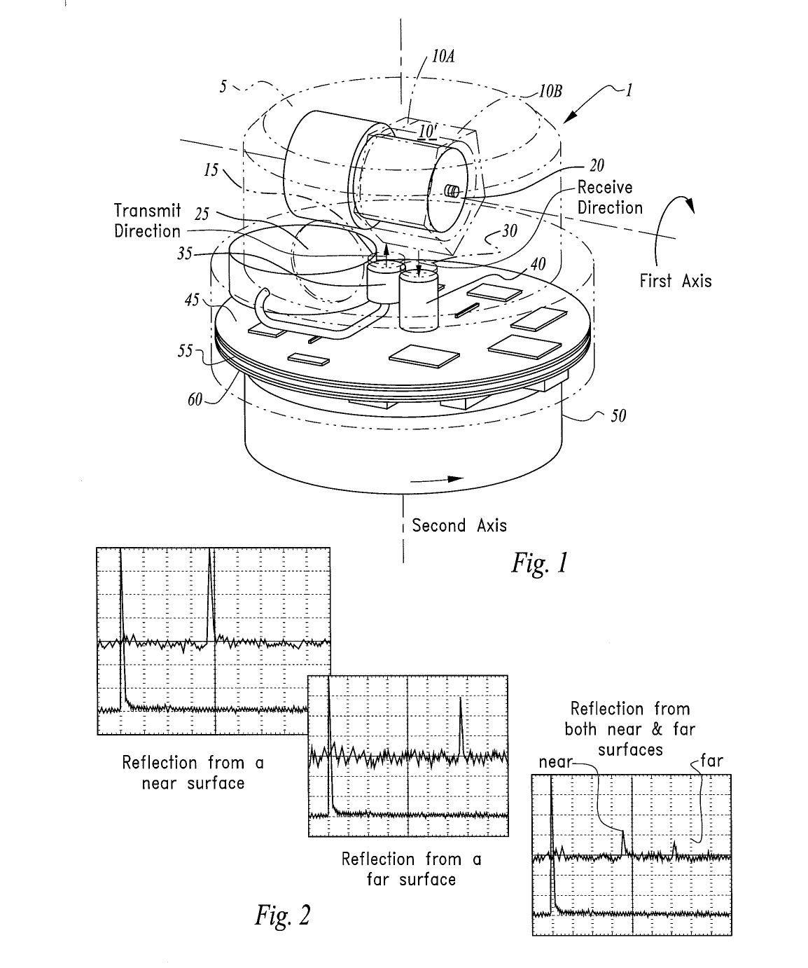

Turning now to the figures wherein like numerals and references define like elements among the several views, FIG. 1 depicts a preferred low-cost, low-SWaP sensor embodiment of the LIDAR system 1 of the invention.

LIDAR system 1 may comprise a scan encoder 5, an elevation scanning element 10 which may be in the form of a geometric solid polyhedron or multi-faceted element comprising a plurality of individual, substantially flat, electromagnetically reflective surfaces or facets 10′ and further comprises beam-forming lens 15. Scanning element 10 may be driven to rotate at a predetermined rate about a first axis by a scan motor 20.

System 1 may further comprise an electromagnetic radiation source or laser source 25, a spectral filter 30, a laser collimating lens element 35, a receiver lens 40, a focal plane detector array (“FPA”) assembly 45, a rotating base or rotation table 50 and a power conditioning and supply assembly 60.

The preferred embodiment of the illustrated LIDAR system 1 below is capable of resolving a cube about 15 cm on each side at about 100 meters distance.

The operating principal of system 1 is, in general terms, a LIDAR imaging assembly that scans a predetermined portion of the elevation of a scene (in a preferred embodiment, 30°) and concurrently scans a predetermined portion of the azimuth of the scene, (in a preferred embodiment, 360°).

System 1 scans a target-illuminating laser beam from laser source 25 on a scene of interest that is shaped using suitable beam-forming optics 15 to fill the image on a suitable focal plane array detector and related readout electronic circuitry that comprises part of the focal plane detector array assembly 45.

Reflected laser “echoes” or returns reflected from the surface of any obstacle along the laser propagation direction are detected by the detector array assembly 45 and the distance to the obstacle calculated based on the laser beam's time of travel. System 1 is capable of detecting multiple returns from the same laser pulse and is therefore capable of imaging scenes behind obstructions such as foliage.

FIG. 2 shows exemplar measurements of different laser returns from multiple range bins in the circuitry of system 1 from a near and a more distant surface and both a near and more distant surface.

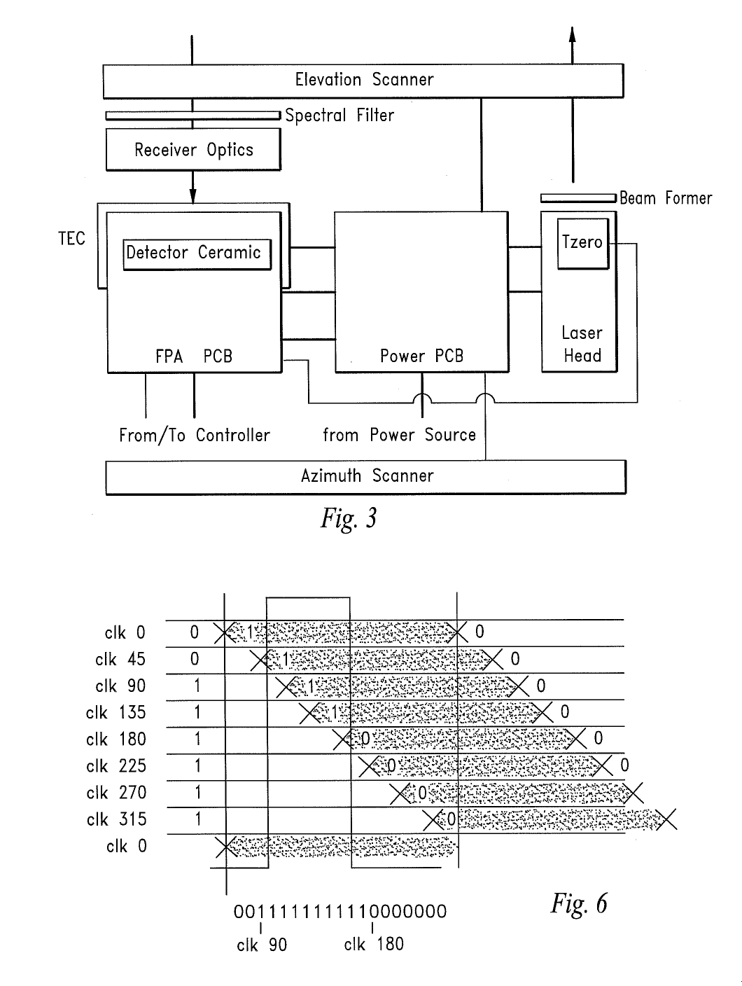

A block diagram of a preferred embodiment of the electronics and its major elements of LIDAR system 1 of the invention are shown in the diagram of FIG. 3.

A preferred embodiment of system 1 of the invention may comprise a suitable fiber laser transmitter source 25 and InGaAs line array receiver as a detector array assembly 45. The electromagnetic beam from the transmitter source is scanned over the scene of interest in the elevation and azimuth axis by means of the cooperation of the rotation of scanning element 10 and rotation table 50. Power may be supplied to system 1 from a host vehicle and conditioned and regulated for use by the LIDAR electronics. The system 1 output is a point cloud set of image data with (x, y, range) coordinates values.

The electronic components of the invention are preferably provided on two printed circuit boards. One board is dedicated to the receiver focal plane detector array assembly 45 and the other to power conditioning and laser timing 60. A thermal electric cooler (TEC) may be used to stabilize the temperature of the detectors of the focal plane detector array element during operation.

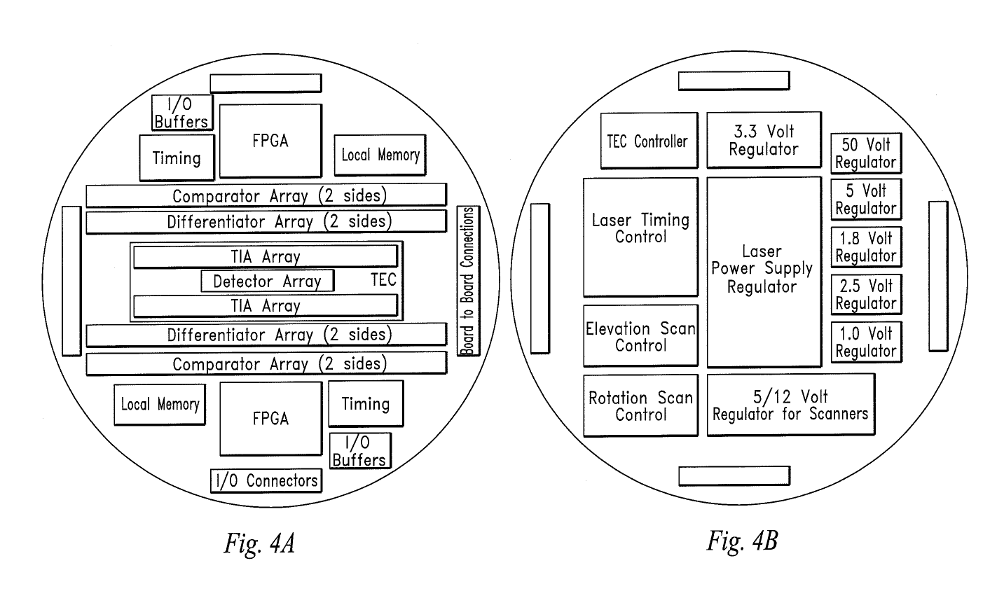

The major functions of system 1 in a two-circuit board embodiment are illustrated in FIGS. 4A and 4B. The focal plane detector array 45 in the illustrated preferred embodiment may comprise 128 linear channels fabricated on an InP substrate.

The detector array substrate may be mounted on a single-sided, single layer ceramic board with a fan-out to one or more individual transimpedance amplifier (TIA) die on the ceramic board. After the detector output currents from the pixels in the detector array are converted to voltage by the TIA, the signals may be routed by means of wire-bonds to a printed circuit board for the remaining “time-to-detection” processing comprising differentiation and threshold exceedence (i.e., signal level crossing) detection by use of comparator circuitry.

As depicted in FIG. 4A, one or more field programmable gate arrays (FPGA) may be provided to sample the output of the comparators of the system 1 to determine the laser echo time of arrival and to process the raw data to generate a point cloud and export to an external controller.

Power supply assembly 60 preferably comprises one or more power regulators for the various power supply voltages needed by the electronics, laser transmitter and elevation and azimuth scanners of system 1. The printed circuit board (PCB) of FIG. 4B may also comprise a controller for the TEC and scanners.

The individual pixel detectors of the focal plane array assembly 45 of the invention may be fabricated on 50 micron centers and the I/O thereof fanned out to provide an active area in the illustrated embodiment of about 5 mm.

On the preferred InP substrate, the detector signals may be fanned to both sides to 100 micron center bonding pads. The detector substrate may be bonded to a ceramic substrate that continues the fan-out to a plurality of TIAs. The TIA die require only one capacitor support each, thus providing a very compact layout for individual components.

The ceramic board may be mounted on a conventional PCB which comprises signal processing components which in turn may comprise one or more operational amplifiers that are configured to be a differentiator-per-channel (two per package), a comparator-per-channel and two FPGAs; one for each of a predetermined number of channels. Both sides of the receiver PCB of FIG. 4A may be used to mount the differentiators and comparators.

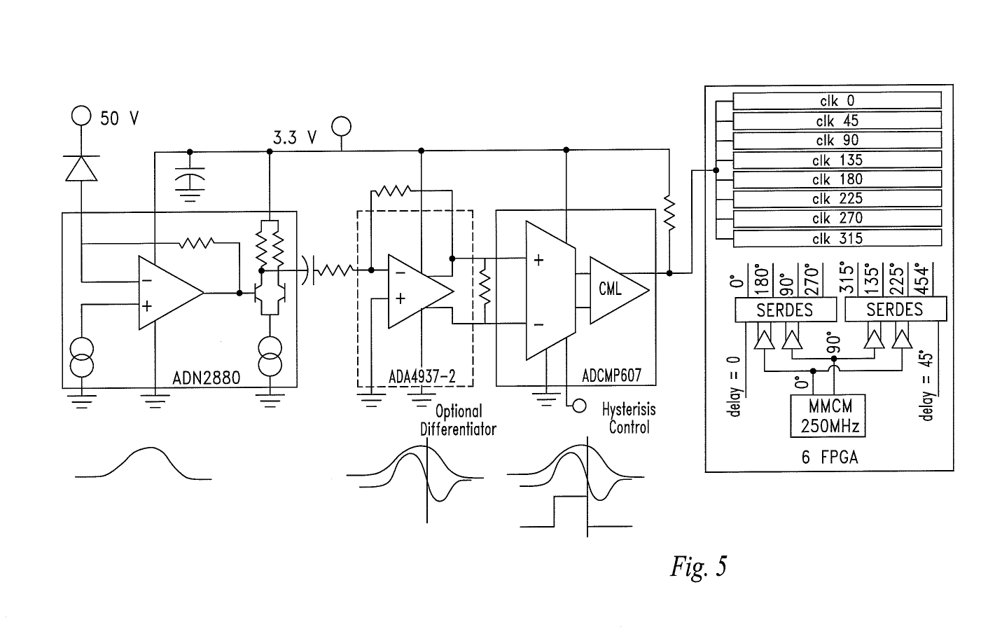

A more detailed FPA circuit block diagram for use in a preferred embodiment of system 1 is shown in FIG. 5 along with related operational waveforms.

In an alternative embodiment of system 1, the detectors may be provided in the form of a linear array of a plurality of InGaAs avalanche photo-diodes (APD) on 50 micron centers. The front-side illuminated diodes may be provided to incorporate micro-lenses so that the “fill factor” of detector assembly 45 is increased.

Exemplar detector specifications for a focal plane detector array 45 of the invention are set out in Table 1 below.

TABLE 1
Detector specification

| | | |
|---|---|---|
| Gain | 10 | |
| Size | 50 um center with | |
| | 20 um active | |
| # channels | 100 | 100 × 1 linear array |
| Physical | Top-side illuminated | Common Cathode InGaAs APD |
| | with micro-lens array | |
| Bandwidth | 2 GHz | |
| Quantum | 0.8 | In active area |
| efficiency | | |
| Wavelength | 1.1 to 1.7 microns | |

Transimpedance amplifiers as are available from Analog Devices, Inc. are well-suited for use with the invention and are specifically designed for operation with photodiodes.

Exemplar TIA specifications for use in a preferred embodiment of the invention are listed in Table 2 below.

TABLE 2

| TIA specifications | ADN2880 | | 0.7 mm × 1.2 mm |
|---|---|---|---|
| Minimum Signal | 1400 | electrons | 1.6 mV |
| Amp Transimpedance | 4400 | l/ohms | |
| Signal Level at TIA output | 1.6 mv differential | | |
| Bandwidth | 2.5 | GHz | |

| | | |
|---|---|---|
| Noise | 8 nA/rt Hz | 140 electrons in |
| | | bandwidth |

The TIAs of the device output a voltage waveform that mimics the return laser echo pulse shape. The TIA's input noise in the illustrated embodiment is about 140 electrons with a minimum signal from the TIA of about 1.6 mV.

Differentiator circuitry suitable for use in the invention may comprise an operational amplifier and external resistors and capacitors. These components desirably permit the TIA output to transition through zero at the peak of the undifferentiated pulse. The differentiator also provides gain to the signal.

Exemplar specifications of a preferred differentiator circuit are given in Table 3 below.

TABLE 3

| Comparator specifications | ADA4937-2 | | 4 mm × 3.75 mm for 2 |
|---|---|---|---|
| Propagation Delay | 1.2 | nsec | |
| Offset Voltage | +/−5 | mV | Hysteresis control |
| Rise/Fall Time | 160 | psec | |
| Random jitter | 2 | psec | |
| Minimum pulse width | 1.1 | nsec | |

In operation, the comparator of the invention changes state at the zero crossings of the input waveform (zero plus the small comparator offset voltage). The comparator trips “high” at the leading edge of the differentiated waveform and at the zero crossing portion of the differentiated waveform. The zero crossing is the most accurate record of the laser echo time-of-flight since this portion of the return signal will not vary with amplitude (range walk).

The output of the comparator is fed into an FPGA for time-of-flight detection. The FPGA may be configured to generate an eight-phase clock using the clock management and SERDES (serializer/deserializer) delay features of the FPGA device. The clock rate in the illustrated embodiment is 250 MHz with an effective sample rate of 2.0 GHz. Each phase of the clock feeds a 256 element FIFO set of range bins. Thus, the entire data FIFO is 2048 bits long. At 7.5 cm each this embodiment provides an active range gate of about 153 meters.

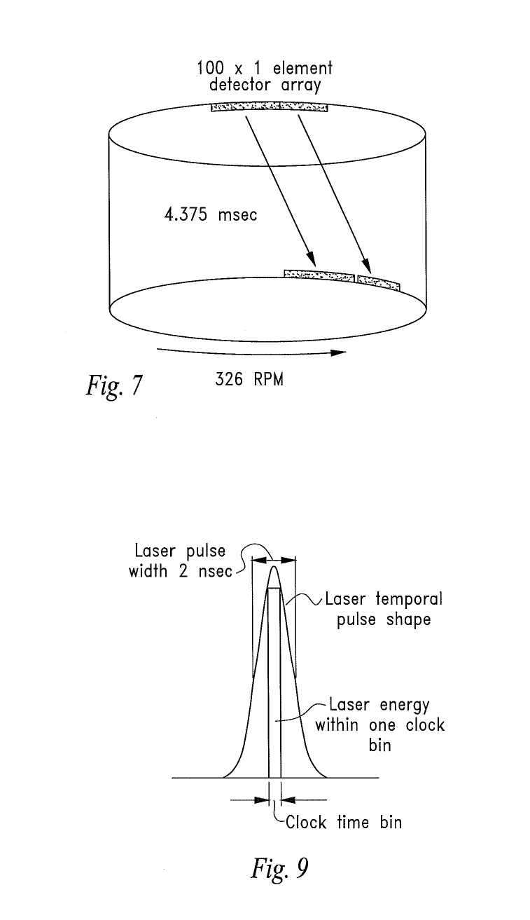

The effect of using an eight-phase clock on a comparator pulse is shown in FIG. 6, illustrating an exemplar one nanosecond comparator pulse feeding an eight-phase parallel sample FIFO running at 250 MHz each.

As illustrated in FIG. 6, Clock 90 first detects the leading edge of the comparator trip. However this edge may have range walk due to amplitude variations. The falling edge of the signal (which represents the peak of the echo) is captured at Clock 180. This technique limits how closely two objects can be detected by the same pixel at different ranges up to 60 cms but will allow many returns (greater than 100) per pixel depending on the return energy.

Further FPGA processing is possible in this embodiment since the data is already present within the device. Such processing may include the conversion of the FIFO bits into a point cloud. The transition from high-to-low in the FIFO can be represented by an 11-bit address. Given two hits per pixel, 100 pixels and 12 microseconds between pulses, the output data rate is about 180 MHz. Parallelizing the output into an 11-bit bus reduces the data rate to under 20 MHz.

A Keopsys fiber laser is well-suited for use as the transmitter of system 1. The fiber laser generates 30 micro joule pulses at 80 KHz at a pulse width of 2 nsec.

Exemplary specifications for the above fiber laser are set forth in Table 4.

TABLE 4
Fiber Laser Parameter

| | | | |
|---|---|---|---|
| Pulse Energy | 30 | uJ | |
| Pulse Duration | 2 | nsec | |
| Wavelength | 1.54 | microns | |
| Rep Rate | 80 | KHz | Variable as needed |

| | |
|---|---|
| Beam quality | 1.2M² |

The LIDAR system 1 of the invention may further comprise two cooperating mechanical scan mechanisms.

The first mechanism is a rotating, multi-faceted polyhedron scan element 10 having a plurality of electromagnetically reflective facet elements 10′ disposed thereon such as the illustrated five-segment polygon elevation scanning element 10 of FIG. 1.

The individual reflective surfaces of reflective facets 10′ perform a shared system function in that a first surface portion 10A of each of facets 10′ is used concurrently as both a transmitter element to scan the laser source of system 1 across the scene of interest and a second surface portion 10B of each of facets 10′ is used as a receiver element to receive and direct reflected laser energy to the detector array assembly 45.

Elevation scanning element 10 may rotate at a first predetermined rate which, in the preferred embodiment, is less than 3,000 rpm.

The second mechanism is a geared rotation table 50 that rotates at a second predetermined rate which, in a preferred embodiment, is about 300 rpm.

In the illustrated embodiment, elevation scanning element 10 will cover about 30 degrees of elevation. Each elevation scan may be comprised of 350 laser shots. Using an 80 KHz laser repetition rate, a single scan requires about 4.375 msec. The scan motor 20 speed may be reduced by having multiple facets 10′ on elevation scanning element 10. The five-facet mirror configuration of FIG. 1 reduces the motor speed to about 2742 rpm. Scan motor 20 has an incremental 5 encoder that will allow about 10 s of micro-radian position accuracy. The elevation scan pattern is a saw-tooth with a near-instantaneous effective flyback. In object space, the elevation scan may be somewhat skewed with respect to the vertical due to the constant rotation of the rotation table 50.

Rotation table 50 of the illustrated embodiment rotates at approximately 326 rpm. The linear dimension of the focal plane detector array 45 requires about 42 elevation scans to cover 360 degrees is depicted in FIG. 7. With each elevation scan requiring about 0.375 msec, one 360 rotation requires about 184 milliseconds (i.e., about 5.44 rps).

The total number of pixels covered in one rotation is thus about 1.47×10⁶ (350×42×100) with a pixel rate is 8 Mpix/sec.

Existing LIDAR-based autonomous navigation systems generate three-dimensional images of the scene based on one of the following concepts: (1) point cloud data, (2) flash LIDAR, and (3) hybrid system.

The prior art point cloud data method relies on scanning a single point on a target illuminated by a laser beam over the entire target geometry. A main advantage of the approach of the instant invention over this prior art approach is that all the laser energy is focused into one point which desirably leads to higher signal-to-noise ratio.

Further, since both the transmitter and receiver are single points on the instant invention, it results in a relatively inexpensive system.

Prior art flash LIDAR systems illuminate the whole target geometry with a laser beam and image that geometry onto a focal plane array, thus acquiring a 3-D laser image instantly. The drawbacks of this prior art approach are that the laser energy is shared among multiple detector pixels and hence have a lower signal-to-noise ratio, and the read-out integrated circuit (ROTC) to acquire range thus becomes complex, resulting in expensive systems. Moreover, the unit cell size of the focal plane array in such a prior art system becomes larger in order to incorporate all the necessary ROTC electronics which, in turn, degrades the spatial resolution of such systems.

The hybrid approach taken by the instant invention is to illuminate a sub-area of the target geometry with the laser beam, then image that sub-area into a detector array. The sub-area is then scanned to generate the three-dimensional image. The advantage of this approach is it acquires 3-D images with good spatial resolution (few tens of micro-radians) in a relatively short time (few milli-seconds) while allowing IC stacking technology to be used to reduce the footprints of the FPA unit cell to levels that result in few tens of micro-radians resolution in a relatively simple optical system.

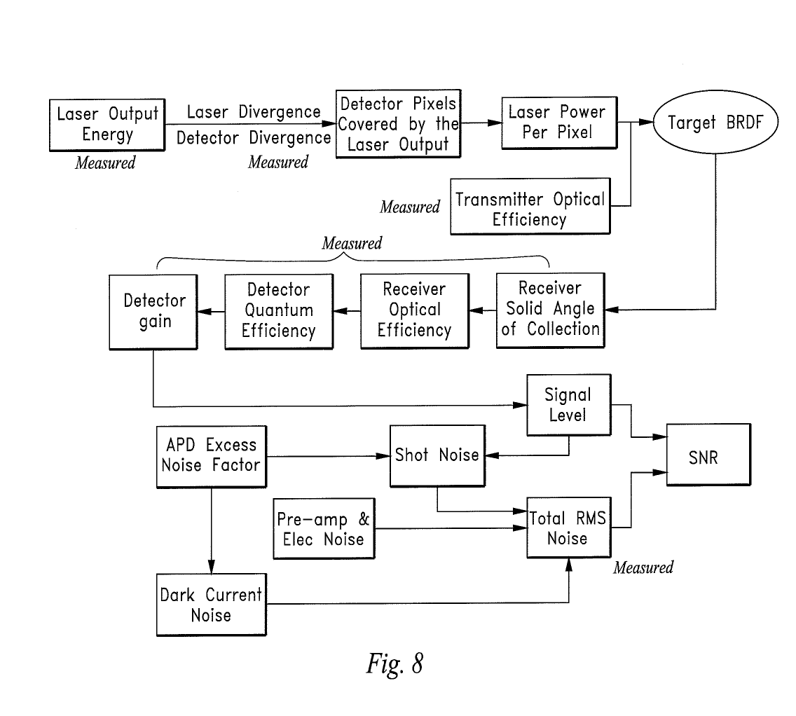

A SNR performance prediction method for system 1 is schematically shown in FIG. 8. The effect of solar background is not included in the flowchart for simplicity. The solar background effect is assumed to be zero in the analysis.

In the analysis of FIG. 8, the signal is calculated at 1 km range. The signal and noise levels are calculated at 1 km and used to scale the signal-to-noise ratio (SNR) at different ranges.

The collected signal energy is calculated from the relationship:

$${E}_{s} = \frac{{E}_{L\_clock}}{{N}_{x} {N}_{y}} {η}_{T} ρ \frac{Ω}{π} {η}_{R} {e}^{- 2 κ R} \\ Where \text{:} \\ \begin{matrix}{E}_{s} & Signal energy & J \text{/} pulse \text{/} pixel \\ {E}_{L\_clock} & Laser energy within one clock bin & J \text{/} pulse \text{/} pixel \text{/} bin \\ {N}_{x} & Laser size in detector pixels ( x \text{-} dir ) & pixel \\ {N}_{y} & Laser size in detector pixels ( y \text{-} dir ) & pixel \\ {η}_{T} & Transmission efficiency & \\ ρ & Surface BRDF - Lambertian & \\ Ω & Solid angle of collection & ster \\ {η}_{R} & Receiver efficiency & \\ κ & Atmospheric extinction coefficient & {Km}^{- 1} \\ R & Range & m\end{matrix} \qquad ( 1 )$$

The laser energy-per-pulse-per-pixel is reduced from the laser output signal due to the fact that the FPA clock speed is much faster than the laser temporal pulse shape. This is illustrated schematically in FIG. 9. Therefore, the amount of laser energy within one clock bin is calculated from the relationship:

$${E}_{L\_clock} = {E}_{L} erf ( \frac{1}{( \sqrt{2} σ clock\_rate )} ) \qquad ( 2 )$$

Where E_{L} is the laser energy-per-pulse-per-pixel and 6 is the laser temporal pulse width (half width at full maximum).

The solid angle is calculated from the relationship:

$$Ω = \frac{π}{4} \frac{{D}^{2}}{{R}^{2}} \qquad ( 3 )$$

Where:
D Aperture diameter
R Range

The solid angle in equation (1) is divided by it because the surface reflectivity is assumed to be constant and corresponds to a Lambertian surface.

The photon energy is calculated from:

$${E}_{p h} = \frac{hc}{λ} \\ Where \text{:} \\ \begin{matrix} {E}_{p h} & Photon energy & J \text{/} photon \\ h & Planck ’ s constant & J . sec \\ c & Speed of light & m \text{/} sec \\ λ & Laser wavelength & micron\end{matrix} \qquad ( 4 )$$

The number of signal photons, nₛ is then determined by dividing the signal energy by the photon energy, i.e.:

$${n}_{p h , s} = \frac{{E}_{s}}{{E}_{p h}} \qquad ( 5 )$$

The detector/electronic system bandwidth is designed to match the laser pulse time. The laser pulse width (full width at half maximum—FWHM) is one of the performance parameters. The bandwidth is determined from the laser pulse width using the relationship:

$$B = \frac{0.5}{{t}_{FWHM}} \\ Where \text{:} \\ \begin{matrix} B & System bandwidth & Hz \\ {T}_{FWHM} & Laser pulse time ( full width at half max ) & sec\end{matrix} \qquad ( 6 )$$

The number of signal electrons generated at the FPA anode is determined by the FPA quantum efficiency and gain through the relationship:

n_{e,s}=n_{ph,s}n_{Q}GFₓ (7)

Where:

n_{e,s} # of anode signal electrons

n_{ph,s} # of photons

n_{Q} APD quantum efficiency

G APD gain

Fₓ pixel fill factor

The dark current noise is usually divided into bulk and surface dark current noise. The surface dark current noise is very small and is neglected. The dark current noise is calculated from the relationship:

[symbol]

i_{n,dark}² [symbol] =2qI_{db}BG²F (8)

The dark current noise is converted into a number of electrons using the relationship:

$${n}_{dark \_ current}^{2} = \frac{〈 {i}_{n , dark}^{2} 〉}{{( 2 qB )}^{2}} \qquad ( 9 )$$

Where:

[symbol] i_{n,dark}² [symbol] ensemble average of the square of the dark current noise

n_{dark} ensemble average of the dark current noise (electrons)

q Electron charge

I_{DB} Bulk dark current noise

B System bandwidth

G APD gain

F Excess noise factor

The shot noise arises from the random statistical Poissonian fluctuations of the signal electrons. The shot noise is calculated from:

[symbol]

i_{n,shot}² [symbol] =2qiₛBG²F (10)

Here, iₛ is the photo-electron current (before any gain or amplification). The shot noise is also calculated as a number of electrons using the relationship:

nₛₕₒₜ²=(n_{ph,s}n_{Q}Fₓ)G²F (11)

The FPA/electronic system total noise is the rms average of the sum of the squares of the individual noise.

Thus:

noiseₜₒₜₐₗ={square root over (nₛₕₒₜ²+n_{dark}_{_{—}}_{current}²+n_{electronic}²)} (12)

The signal-to-noise ratio is calculated from:

$$SNR = \frac{\# of signal electrons}{\# of noise electrons} \qquad ( 13 )$$

Table 5 lists exemplar parameters of system 1 of the invention and shows the performance of such a system.

TABLE 5

| Parameter | Value | Units |
|---|---|---|
| Laser | | |
| Laser energy per pulse | 45.00 | □J/pulse |
| Number of required laser pulses per second | 74 | kHz |
| Laser wavelength | 1.536 | □m |
| Laser pulse width | 2 | nsec |
| Laser overlap pixels in x-direction | 4 | |
| Laser overlap pixels in y-direction | 0 | |
| Laser Size in pixels (x-direc) | 100 | pixels |
| Laser Size in pixels (y-direc) | 1 | pixels |
| Number of scene updates per second | 5 | Hz |
| Optics | | |
| Transmission efficiency | 80.00% | |
| Receiver efficiency | 70.00% | |
| Total optical efficiency | 56.00% | |
| Atmospheric extinction - clear | 5.83E−02 | km\hat{ }−1 |
| Aperture diameter | 2 | cm |
| Instantaneous Field of View (IFOV) | 1.5 | mrad |
| Azimuth field of regard | 360 | degrees |
| Elevation field of regard | 30 | degrees |
| Minimum SNR | 10 | |
| Target | | |
| Surface reflectance asphalt | 0.1 | |
| Surface reflectance foliage | 0.8 | |
| Surface reflectance average | 0.5 | |
| Receiver | | |
| System bandwidth | 384.62 | MHz |
| Receiver filter | 30 | nm |
| Detector pixel size (x-direc) | 100 | pixels |
| Detector pixel size (y-direc) | 1 | pixels |
| Detector pixel dimension | 50 | micron |
| Detector gain | 10 | |
| Detector quantum efficiency | 0.8 | |
| Dark current | 1 | nA |
| Excess noise factor | 1.3 | |
| Detector active size | 20 | micron |
| Electronic noise | 8 | pA/Hz\hat{ }1/2 |
| Clock rate | 2 | GHz |

The rotation table 50 provides full azimuth coverage at a 5 Hz rate and may be made to operate in a sector scan mode where a sector of the azimuthal field is repeatedly searched at faster sector frame rates.

The receiver optics of system 1 may be provided with a 2× zoom capability that can increase the azimuth and elevation spatial resolution by a factor of two. This occurs at the expense of the azimuth width of each of the 30-degree elevation swaths but does not impede achieving rapid sector scans.

A combination of the full azimuth scanning mode and the sector scanning mode may be achieved by rapid interleaving of the modes. This desirably maintains full azimuth viewing at a somewhat reduced frame rate but allows specific regions of high interest to be examined at higher rates and with higher resolutions.

The use of SWIR fiber laser technology provides a capability for near-instantaneous control and adjustment of the pulse energy over a very broad range of pulse rates.

This capability can be exploited in two fundamental fashions. First, increasing pulse energy enhances the signal-to-noise ratios in specific elements of the scene when in a sector scan mode. Second, decreasing the pulse energy to the point where the sensor system is performing satisfactorily but with no excess margin will limit the area over which adversary SWIR passive sensors might detect the pulse energy. This inherently lowers the detectability of the LIDAR.

The presence of an adversary electro-optical sensor capable of potentially detecting laser illumination from the LIDAR may result in a retro-reflected pulse being returned to the LIDAR system 1 and detected there. The agility of the laser operation may then be exploited to blank the laser pulses in subsequent scans in the region of the retro-reflection return, leaving the adversary with only one pulse from the LIDAR upon which to make a detection. Exploitation of this pulse blanking technique significantly contributes to the low observability of the LIDAR system.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

We claim:

1. An electronic LIDAR imaging system comprising:
an electromagnetic radiation source for transmitting an electromagnetic beam in a predetermined range of the electromagnetic spectrum,
a scanning element comprising at least one substantially flat and electromagnetically reflective facet disposed about a perimeter of the scanning element,
the scanning element configured to rotate about a first axis in a first direction whereby the transmitted beam is scanned in the first direction across a scene by the facet,
a rotation table configured to rotate and scan the transmitted beam across the scene in a direction substantially orthogonal to the first direction, and,
a focal plane detector array for converting a reflected portion of the beam from the scene from the facet into a detector output signal.

2. The LIDAR system of claim 1 configured to output a point cloud set of image data with (x, y, range) coordinates values.

3. The LIDAR system of claim 1 wherein the scanning element comprises a geometric solid polyhedron reflective scanning and receiving element.

4. The LIDAR system of claim 3 wherein the scanning element comprises at least five electromagnetically reflective facets.
